(19) United States
(12) Patent Application Publication
(10) Pub. No.: US 2018/0040038 A1
(43) Pub. Date: Feb. 8, 2018

(54) SYSTEM AND METHOD FOR MANAGING AND INTERACTING WITH SPECTATORS AT AN ACTIVITY VENUE

(71) Applicant: FAIRWAYIQ, INC., Waltham, MA (US)

(72) Inventors: David J. Vanslette, Wayland, MA (US); James K.B. Nunn, Wayland, MA (US); Lucius Riccio, New York, NY (US); Miro Jelicic, Brookline, MA (US)

(21) Appl. No.: 15/667,449

(22) Filed: Aug. 2, 2017

Related U.S. Application Data
(60) Provisional application No. 62/371,065, filed on Aug. 4, 2016.

(51) Int. Cl. G06Q 30/02; H04W 4/02

(52) U.S. Cl. CPC G06Q 30/0281; H04W 4/02

(57) ABSTRACT

A method and system for managing a plurality of spectators at an activity venue, suitable for improving an experience of the spectators at the activity venue. In particular, the present invention relates to tracking locations of participants, staff, equipment, and spectators at the activity venue and optimizing a spectator experience by directing recommended spectator movement based on the tracked locations. A data management tool is used to obtain the data necessary to track participants, staff, and spectators within an activity venue to enable live traffic control of the spectators, provide predictive analytics related to gameplay and flow of traffic, and provide operators and spectators with information necessary to maximize spectator experience of events at the activity venue.

### CROSS-REFERENCE TO RELATED APPLICATION(S)

This application claims priority to, and the benefit of, co-pending U.S. Provisional Application 62/371,065 filed Aug. 4, 2016 for all subject matter contained therein. The disclosures of all said provisional application is incorporated herein by reference in their entirety.

### FIELD OF THE INVENTION

The present invention relates to managing a plurality of spectators at an activity venue in a manner that improves an experience of the spectators at the activity venue. In particular, the present invention relates to tracking locations of participants, staff, equipment, and spectators at the activity venue, and providing the spectators with feedback to manage their locations for an improved participation experience (and providing the activity venue operator with feedback necessary to manage the spectator experience).

### BACKGROUND

Generally, activity venues can host events to provide exposure and supplemental income to the activity venue. The events can include activities and sub-activities for spectator participation and/or spectator viewing of others participating in activities or sub-actives. Examples of such events include expos, conventions, tournaments, lectures, stadiums, etc. The activity venues often provide maps, guides, pamphlets and more recently, mobile applications to the spectators to convey information about the hosted event(s). The information can include a map of the activity venue, including identifiers for the different activities or sub-activities and locations thereof. The map can also include identifiers for locations of different points of interest unrelated to the activities at the activity venue. For example, the map can include identifiers for locations of concessions, restrooms, merchandise, first aid, etc.

Additionally, in the case of mobile applications, the map can periodically update to include locations of participants (e.g., presenters, performers, athletes, etc.) and other information related to those participants participating in the host events. Typically, the locations of the participants are tracked by staff members and/or volunteers marking the participants (e.g., with lasers) to be tracked by a management system. The management system can also receive statistical and other information about the participants' performance and provide the combined location and statistical information to spectators through the mobile application.

However, the traditional use of maps, guides, pamphlets, and mobile applications experience some shortcomings. In particular, traditional maps, guides, and pamphlets include maps for various activity venues but are limited to static indicators for points of interest (e.g., restrooms, concessions, merchandise, presentations, shows, etc.) throughout the activity venue and locations of participants at the venue. Similarly, mobile applications with maps for activity venues also include static identifiers for locations throughout the activity venue and may optionally include periodically updated location information for participants at the activity venue (e.g., athletes at a sporting event). The location information for participants provided in conventional mobile applications, however, is unreliable because they need to be manually updated periodically (e.g., using a combination of volunteers and lasers). Accordingly, the more frequently participant location information is updated, the greater the expenditure of resources is required. For example, more volunteers/staff members are required to locate and mark participants for the tracking system. Additionally, in events where the participants are mobile (e.g., golf, gymnastics, skiing, marathon, triathlon, tennis tournament, etc.) these systems cannot accurately predict where a participant will be at a future point in time because the systems require “eyes on” the participant to provide the location. Similarly, at large scale events (e.g., the Olympics) there are a large number of participants and events going on simultaneously which are extremely difficult to track at the same time using conventional technologies and methodologies.

Moreover, traditional maps, guides, pamphlets, and mobile applications cannot provide pedestrian traffic information for spectators attending the events at the activity venue. In particular, the conventional methodologies and systems cannot provide spectators with real-time information on areas that are overly crowded or will be overly crowded at a particular point in time in the future. In other words, traditional methodologies do not take into account current traffic flow of the spectators throughout the entire venue and do not compensate for bottlenecks caused by spectator traffic. Additionally, these conventional methods lack the tools necessary to track data related to the traffic of spectators and to use the data to maximize the throughput of the spectators and/or capitalize on a high density of spectators (e.g., providing concessions, merchandise, etc.). Instead, any adjustments made by operators at an activity venue rely solely upon in-person observations of the activities and spectators, and making the adjustments according to such in-person observations. As such any adjustments provided by conventional methods/systems are reactive and not predictive or proactive. As a result of the above-noted shortcomings, the conventional methods and systems lack the functionality to provide users notifications or predictions regarding areas of congestion, where participants will be at a given point in time, and/or how to navigate to those locations while avoiding crowded areas.

Furthermore, during periods of high volume of spectators, it is difficult for the operators of the venue to maintain the venue around spectators. Typically the staff is inefficient as they have to wait to perform maintenance tasks in between spectator use (e.g., off hours, between shows, etc.). At large venues performing maintenance between spectators is extremely challenging because it is unclear where all of the spectators are at any given moment. As a result, operators at large venues and/or events also have difficulty performing such maintenance activates efficiently. Additionally, operators do not always know where the staff is physically located at the venue or the amount of time they spend in areas performing certain tasks. Similarly, operators also frequently do not know where each piece of equipment is at any moment and must coordinate equipment usage through inefficient methods. The lack of real time staff and equipment location information yields further inefficiencies in time and cost management for the venue and ultimately lack the delivery of a consistent experience for spectators.

### SUMMARY

There is a need for a management tool that provides spectators with an improved experience at an activity venue, in particular during an event with a plurality of participants (e.g., presenters, performers, athletes, etc.) and/or activities at the activity venue. Additionally, there is a need for a management tool that allows more time and cost efficient ways to manage/maintain a venue based on spectator traffic and participant behavior. Specifically, there is a need to independently obtain data to track locations of participants and spectators within an activity venue and to enable real-time control of the spectators and their viewing of participants in activities at the venue. In particular, there is a need to provide predictive analytics related locations of participants, a flow of spectator traffic/levels of congestion, and provide operators and spectators with information necessary to maximize usage of the venue during an event and thereby improve the experience of the spectators at the activity venue. Moreover, there is a need to connect operators in control of staff and venue equipment, with spectators to orchestrate and manage large venues and events at those venues effectively and efficiently. Overall, there is a need to provide a solution to maximize spectator experiences at activity venues. The present invention is directed toward further solutions to address these needs, in addition to having other desirable characteristics.

In accordance with an embodiment of the present invention, a system for real-time event management for use within an activity venue hosting an event is provided. The system includes a wireless gateway and a plurality of sensor devices associated with a plurality of participants in the event for disposition and transportation throughout the activity venue. Each of the plurality of sensor devices includes a location sensor that provides location and time data of the plurality of sensor devices at different points in time within the activity venue. Each of the plurality of sensor devices also includes a wireless communication device that communicates with the wireless gateway by transmitting the location and time data from the plurality of sensor devices to the wireless gateway, enabling the system to establish a real-time location of each of the plurality of participants in the event based on location of the plurality of sensor devices within the activity venue. The system also includes event experience applications executing on one or more spectator devices, each of the one or more spectator devices associated with spectators attending the event. The system further includes event management applications executing on one or more operator devices, each of the one or more operator devices associated with operators of the activity venue. The system also includes a data management tool configured to provide the event management experience and the event management applications with real-time location information of the plurality of sensor devices associated with the plurality of participants.

In accordance with aspects of the present invention, the one or more spectator devices include location services that provide location and time data indicating a location of the one or more spectator devices at different points in time within the activity venue. The one or more spectator devices also include a wireless communication device that communicates with the system by transmitting the location and time data from the one or more spectator devices to the system, enabling the system to establish a real-time location information for each of the one or more spectator devices, and therefore spectators associated therewith, within the activity venue.

In accordance with aspects of the present invention, the data management tool receives location and time data for each of the plurality of participants from the plurality of sensor devices via the wireless gateway and receives location and time data for each of the spectators directly from the event experience applications executing on the one or more spectator devices. Additionally, the data management tool transforms the location and time data from the plurality of sensor devices and the location and time data from the one or more spectator devices into predicted location data indicating anticipated locations of each of the plurality of participants and each of the spectators within the activity venue at future times.

In accordance with aspects of the present invention, the predicted location data includes prediction of a future location of the plurality of participants at a future point in time based on a rate of progress of the plurality of participants. In accordance with aspects of the present invention, the data management tool measures and predicts congestion of spectators within the activity venue based on the location and time data for each of the one or more spectator devices. In accordance with aspects of the present invention, the data management tool recommends locations for point-of-sale terminals based on predetermined characteristics of the activity venue and the location and time data for each of the one or more spectator devices. In accordance with aspects of the present invention, the data management tool receives sales data from the point-of-sale terminals located at the activity venue. In accordance with aspects of the present invention, the data management tool pre-emptively issues notifications to the one or more operator devices to instruct the operators to perform management tasks at one or more specific locations within the activity venue based on the received sales data and the measured and predicted congestion of spectators within the activity venue. In accordance with aspects of the present invention, the notifications issued to the one or more operator devices include at least one of crowd control instructions, dispatch venue vehicles to transport spectators, cash out instructions, refreshment restocking instructions, and cleaning instructions.

In accordance with aspects of the present invention, the system further includes one or more venue asset tags communicating with the wireless gateway and providing location and time data for the one or more venue asset tags. In accordance with aspects of the present invention, the one or more venue asset tags are attachable to, or integrated into, at least one of a piece of venue equipment, a venue vehicle, refuse containers, and a venue sign.

In accordance with aspects of the present invention, the data management tool is further configured to provide information to at least an operator of the activity venue, the information related to at least one of: sub-activity time management, participant matching, live traffic control, statistics related to tracked movements of the one or more spectator devices, predictive analytics of the one or more spectator devices, layout of the activity venue, and maintenance of the activity venue. In accordance with aspects of the present invention, the data management tool provides information to the one or more spectator devices within the activity venue, the information related to at least one of: rate of progress for the plurality of participants, sub-activity start times, statistics, and weather.

In accordance with aspects of the present invention, each of the plurality of sensor devices includes at least one of a bag tag, a key chain, equipment tag, cell phone application, and a card. In accordance with aspects of the present invention, the wireless gateway includes a long range wide area network (LoRa) gateway. In accordance with aspects of the present invention, the data management tool is a cloud based computing device infrastructure. In accordance with aspects of the present invention, the data management tool is further configured to provide navigation instructions to the one or more spectator devices through the event experience applications.

In accordance with aspects of the present invention, the navigation instructions include best route navigation instructions between a location of one of the one or more spectator devices to a point of interest at the activity venue based on the location and time data for each of the one or more spectator devices and the location and time data for each of the plurality of spectators. In accordance with aspects of the present invention, the point of interest includes at least one of: one or more of the plurality of participants, a particular point of sale terminal, restrooms, and areas of low congestion of spectators.

In accordance with embodiments of the present invention, a method for real-time event management for use within an activity venue hosting an event using a system for real-time event management is provided. The method includes the system associating a plurality of sensor devices with a plurality of participants in the event for disposition and transportation throughout the activity venue. Each of the plurality of sensor devices include a location sensor that provides location and time data of the plurality of sensor devices at different points in time within the activity venue and a wireless communication device that communicates with a wireless gateway by transmitting the location and time data from the plurality of sensor devices to the wireless gateway to establish a real-time location of each of the plurality of participants in the event based on location of the plurality of sensor devices within the activity venue. The method also includes the system receiving location and time data from the plurality of sensor devices, the system performing analytics on the location and time data received from the plurality of sensor devices, and the system creating display information based on the analytics for users of each of the plurality of sensor devices. The method further includes the system generating the display information and providing the display information to the users of each of the plurality of sensor devices with real-time location information of the plurality of sensor devices associated with the users.

### BRIEF DESCRIPTION OF THE FIGURES

These and other characteristics of the present invention will be more fully understood by reference to the following detailed description in conjunction with the attached drawings, in which:

FIG. 1 is an illustrative system for implementing the steps in accordance with the aspects of the present invention;

FIGS. 2A and 2B are illustrative architectures of the sensor device(s), in accordance with the aspects of the invention;

FIG. 3 is an illustrative flowchart depicting operation of the data management tool, in accordance with aspects of the invention; and

FIG. 4 is a diagrammatic illustration of a high level architecture configured for implementing processes in accordance with aspects of the invention.

### DETAILED DESCRIPTION

An illustrative embodiment of the present invention relates to tracking locations and rate of progress of participants in an event at an activity venue, tracking locations of spectators at the activity venue, and providing spectators with feedback related to locations of participants and other spectators for an improved experience of the event. In particular, the present invention utilizes the locations of participants and spectators and during an event at an activity venue to determine various metrics that can be used by spectators and operators of the venue to enhance the spectator experience through optimization of the event venue and the efficiency by which staff can operate the venue. Additionally, the present invention can track locations of staff, security and venue assets located throughout the activity venue. Accordingly, locations for each participant, spectator, and venue asset throughout the activity venue are tracked and analyzed by the event management system in real-time. The tracking and analysis of participants, spectators, and venue assets are performed utilizing a specific combination of hardware devices and processing steps to yield a result which would be unrealistic if not impossible to execute utilizing human personnel alone. Results of the analyzed data by the event management system can be provided to operators and spectators through an event management application and an event experience application, respectively on their personal mobile computing devices.

As utilized herein, participants are defined as individuals who are competing or otherwise participating in an event at the venue that is being viewed by bystanders. For example, participants at a tennis tournament event are the tennis players (e.g., participants) playing tennis on one or more tennis courts (e.g., venue) available for viewing by a plurality of other individuals bystanders. As utilized herein, spectators are defined as the individuals who are viewing the participants of the event. For example, spectators at a tennis tournament event are the bystanders viewing the tennis players as they play tennis. As utilized interchangeably herein, operators and/or staff are defined as individuals who are employed by or otherwise associated with the venue/event and are responsible for operating the event or the venue. For example, operators or staff at a tennis tournament can include organizers of the event, managers of various event operations, maintenance staff of the tennis courts, security, rules officials, and surrounding areas, etc.

In accordance with the present invention, the participants and venue assets (e.g., equipment, vehicles, etc.) are provided with a specialized sensor device configured to report location and other operational metrics like engine temperature, load, operating hours, working hours, general status (on, off, idle), fuel usage etc., and time information of the participants and venue assets throughout the venue to a data management system. The location and time information may be relayed to a central venue device for processing prior to being transmitted to the data management system. In accordance with one example embodiment, the location and time information is transmitted to a local or cloud computing system for analysis and resulting output is transmitted via mobile applications. Similar to the specialized sensor devices, mobile applications running on operators' and spectators' personal mobile devices are leveraged to obtain similar location and time information about the operators and spectators and provide the information to the computing system. The local or cloud computing system can include the data management tool configured to analyze the received location and time data for the participants, spectators, staff members, and venue assets with a focus on evaluating locations of event participants, congestion levels of spectators, and locations of the venue assets and staff members throughout a particular venue.

The local or cloud computing system can utilize a live (e.g., real-time) look-in of the obtained location data for all participants, spectators, staff members, and venue assets to make determinations related to congestion and can record the location information over time to accurately estimate wait times, predict future points of congestion of spectators, and/or identify other issues. Additionally, the cloud computing system can utilize the data to make observations to take into consideration during those determinations. For example, the computing system can identify a high density of spectators at a location associated with a particular participant and predict that when the participant changes location, the density of spectators will adjust accordingly (e.g., decrease in the former location and increase in the future location of the participant).

In accordance with an example embodiment of the present invention, each participant at the activity venue can also be assigned a rate of progress value, using a combination of the live location data and historically received location data for that participant and other participants. Using the rate of progress value for all of the participants at a venue, the computing system can perform additional analysis of the data and predict the future locations for the participants. The predicted locations for each participant can thereafter be provided to spectators and operators at the activity venue (e.g., via mobile applications) such that the spectators and operators can remain informed as to where the participant will be at a future point in time. Accordingly, spectators can plan ahead where/when they want to be to view the participant at the event and allocated an amount of time to get to the future location. Additionally, once the computing system has performed the analysis and identified current points of congestion for spectators (and any potential trouble spots), mitigating instructions can be determined and proactively sent to spectators and operators at the venue as preventative measures. For example, the mobile application can provide spectators with directions for navigating the activity venue to reach a target location while avoiding identified points of spectator congestion. Accordingly, based on the congestion of spectators in the activity venue, the computing system can recommend that spectators take certain pathways to desired locations. Such mitigating action has numerous benefits including but not limited to reducing current points of congestion, improved experience for spectators being able to avoid points of congestion, avoiding points of congestion from occurring at all, enabling spectators to avoid future predicted points of congestion, etc.

In accordance with an example embodiment of the present invention, the computing system can leverage location information to provide administrators and operations staff of the activity venue with optimal locations for merchandise, concessions, etc. based on current and future locations of spectator congestion. Maintenance superintendents can also benefit from data related to how long staff members spend performing specific tasks, at specific locations, and with what specific maintenance equipment the tasks are being performed. Additionally, data pulled from the equipment control area network (CAN) bus is used to predict maintenance on a specific piece of equipment and alert mechanics to equipment that needs immediate repair. The computing system can also recommend specific works and/or types of maintenance to be performed within the activity venue based on data aggregated from throughout the venue. In particular, the computing system and sensor device(s) and/or operator device(s) associated with both staff and venue assets (e.g., equipment) reports on staff location, equipment location, effectiveness, and ultimately serve as a dispatch system combined with a mobile phone application used to present information to both supervisors and staff. Additionally, the computing system provides a dispatch system that utilizes the spectator data to recommend maintenance schedules and activities that efficiently work around and in between spectators. The dispatching can be conveyed via the specialized devices and/or mobile application installed on personal computing devices.

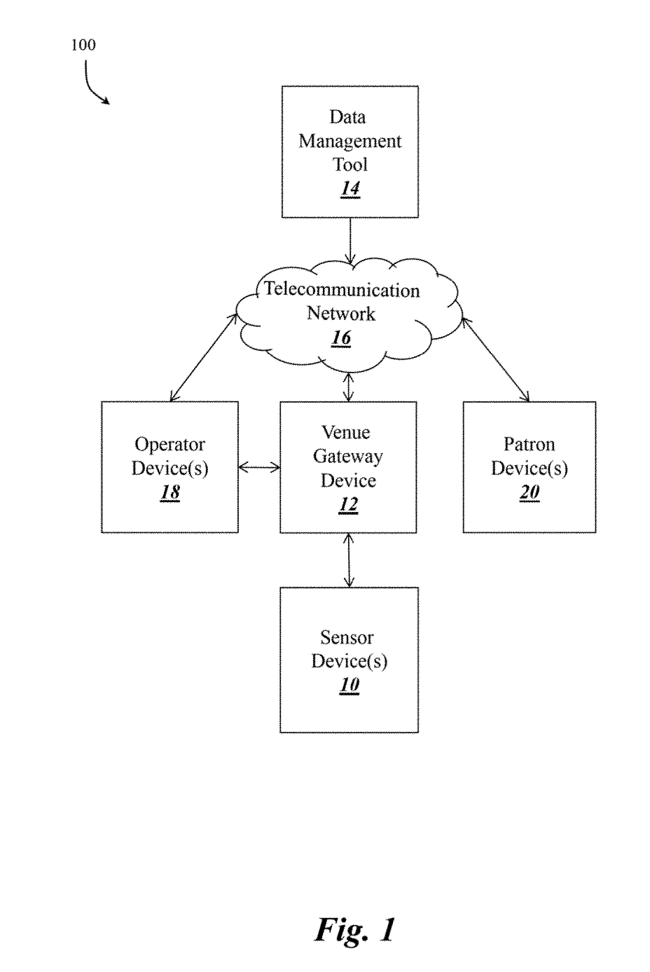

FIGS. 1 through 4, wherein like parts are designated by like reference numerals throughout, illustrate an example embodiment or embodiments of the spectator management system, according to the present invention. Although the present invention will be described with reference to the example embodiment or embodiments illustrated in the figures, it should be understood that many alternative forms can embody the present invention. One of skill in the art will additionally appreciate different ways to alter the parameters of the embodiment(s) disclosed in a manner still in keeping with the spirit and scope of the present invention.

FIG. 1 depicts an illustrative environment for implementing aspects of the present invention. In particular, FIG. 1 depicts a computing system 100 for use in conjunction within an activity venue to obtain data related to participants, spectators, operators/staff, and venue assets within the activity venue. The system 100 is configured to utilize the obtained data to manage and provide information to the participants, spectators, staff, venue assets, and the activities or sub-activities throughout an activity venue. In particular, the system 100 can obtain and aggregate data related to location and time (e.g., via timestamp, clock time, etc.) associated with each participant, spectator, operator/staff member, and venue asset within a venue. In accordance with an example embodiment of the present invention, the system 100 includes sensor device(s) 10, a venue gateway device 12, a data management tool 14, a telecommunication network 16, operator device(s) 18, and spectator device(s).

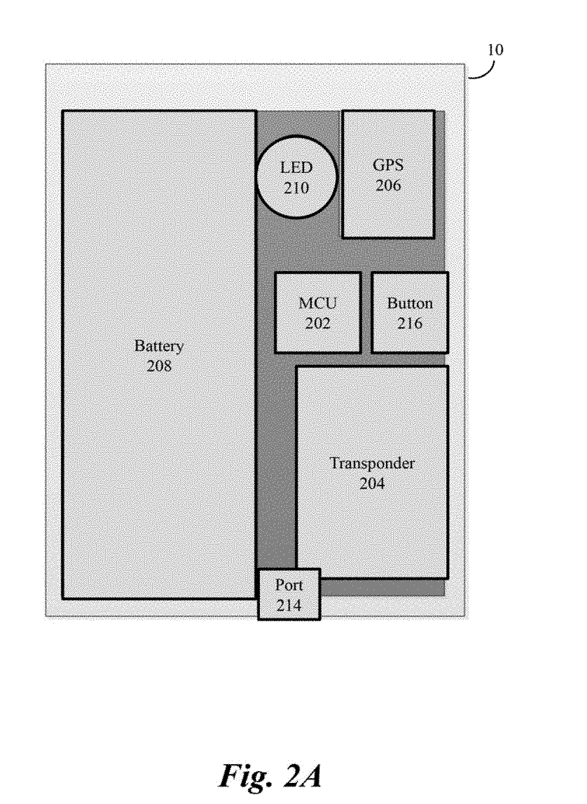

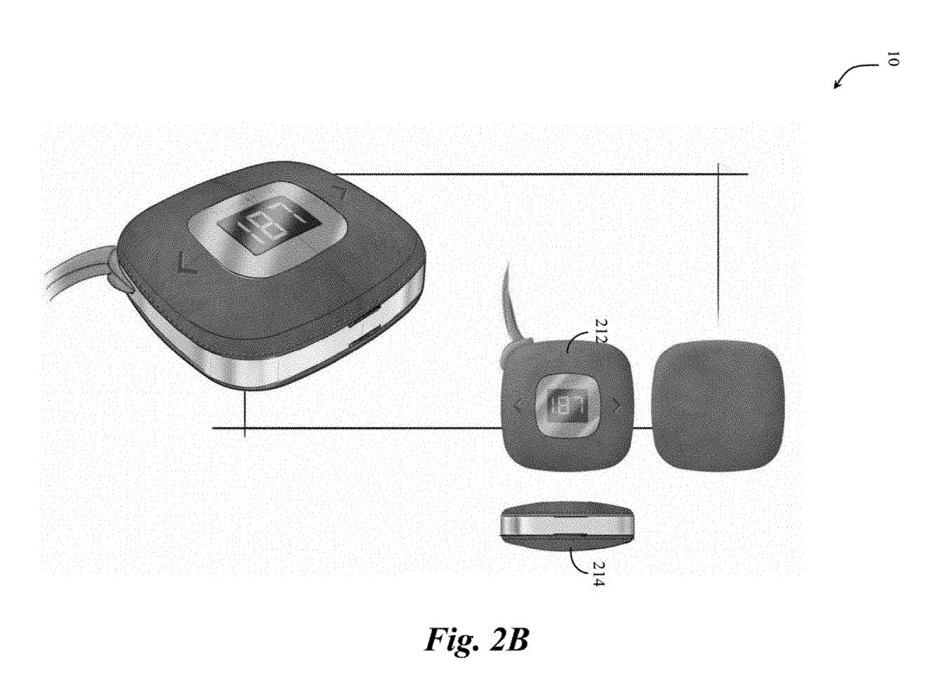

In accordance with an example embodiment of the present invention, the sensor device(s) 10 are specialized mobile sensor devices with specialized functions related to providing location information of event participants, staff, and/or venue assets in accordance with the present invention. The sensor device(s) 10 can include, as depicted in FIG. 2A, a microcontroller (MCU) 202, a transceiver 204 with antenna, a global positioning system (GPS) locator 206, a battery power source 208, a light emitting diode (LED) 210, and a display, such as a low power display (e.g., an electronic ink (e-Ink) display). The device sensor(s) 10 are configured to gather location data for the device in real-time and transmit the location data to a venue gateway device 12. As would be appreciated by one skilled in the art, the device sensor(s) 10 can also transmit additional data along with the location data. For example, the device sensor(s) 10 can also include timestamp and identifier data associated with the device sensor(s) 10 (and optionally a user of the device sensor 10) to be transmitted to the venue gateway device 12.

In accordance with an example embodiment of the present invention, the location and time data is transmitted from each of the sensor device(s) 10 to the venue gateway device 12 over a wireless telecommunication network 16, such as for example, a long range wide area network (LoRa). In particular, the location and time data is transmitted over a narrow band radio frequency (RF) telecommunication network 16 (such as, for example, LoRa). As would be appreciated by one skilled in the art, the location and time data can be transmitted over any suitable communication platform known in the art (e.g., cellular network, narrow band radio frequency, Wi-Fi, LoRa, etc.). The venue gateway device 12 can be any computing device configured to receive data from the sensor device(s) 10, optionally analyze the data, and provide information based on the analysis of the data (e.g., location information) to spectator devices 20, operator device(s) 18, and/or staff carrying the sensor device(s) 10 in a non-intrusive manner. As would be appreciated by one skilled in the art, the venue gateway device 12 can be a computing device similar in structure to the sensor device(s) 10, it can be a general purpose computer specifically configured, or it can be a specialized computer system operable to communicate with the sensor device(s) 10. For example, as would be appreciated by those of skill in the art, the venue gateway device 12 can include a single computing device, a collection of computing devices in a network computing system, a cloud computing system, or a combination thereof. In accordance with an example embodiment of the present invention, the venue gateway device 12 is a centralized LoRa computing device operable to communicate with and aggregate data from each of the sensor device(s) 10 throughout the activity venue over a LoRa network. Similarly, the venue gateway device 12 can be configured to exchange data and communicate directly with one or more operator device(s) 18 located throughout the activity venue.

The venue gateway device 12 can also be configured to communicate with a data management tool 14. In accordance with an example embodiment of the present invention, the data management tool 14 is a cloud based computing device or other centralized computing system configured to communicate with the venue gateway device 12, operator device(s) 18, and spectator device(s) 20 over the telecommunication network 16. In particular, the venue gateway device 12 communicates the location and time data received from the sensor device(s) 10 and operator device(s) 18 to the data management tool 14 for additional processing. Additionally, the data management tool 14 can relay information (e.g., traffic data) to the venue gateway device 12 to communicate back to the sensor device(s) 10, the operator device(s) 18, and spectator device(s) 20. As would be appreciated by one skilled in the art, the data management tool 14 can also communicate directly with the sensor device(s) 10, the operator device(s) 18, and spectator device(s) 20.

As would be appreciated by one skilled in the art, the data being communicated between the venue gateway device 12 and the other devices 10, 18, 20 can be encrypted and securely transmitted. For example, the venue gateway device 12 communicates with other devices over the LoRa network, which is a closed secure network that sends encrypted packets of information. Similarly, the data management tool 14 can received location and time information from the operator device(s) 18 and spectator device(s) 20 independently from the venue gateway device 12. For example, the computing devices 12, 14, 18, 20 are configured to establish a secure connection and communicate over a telecommunication network 16. As would be appreciated by one of skill in the art, the telecommunication network 16 can include any combination of known networks. For example, the telecommunication network 16 can be combination of a mobile network, WAN, LAN, or other type of network. The telecommunication network 16 can be used to exchange data between the venue gateway device 12, the data management tool 14, device(s) 18, and spectator device(s) 20.

In accordance with an example embodiment of the present invention, the data management tool 14 is a cloud computing and storage environment configured to collect, aggregate, analyze, and provide metrics using location and time data received from various activity venues. The data management tool 14 can also include a database management system utilizing a given database model configured to interact with a user for analyzing the received and stored data (e.g., stored in a database model). Additionally, the data management tool 14 can analyze the collected location data, time data, and other information to distribute instructions and/or feedback information to the venue gateway device 12, the sensor device(s) 10, operator device(s) 18, and/or spectator device(s) 20.

In accordance with an example embodiment of the present invention, the computing and database storage environment of the data management tool 14 performs analytics through a web application and delivers the results of the analytics through the web and/or mobile applications to user devices (e.g., the sensor device(s) 10, operator device(s) 18, and/or spectator device(s) 20). For example, the delivered data can inform users of venue usage, locations of participants or activities, rate of progress of the participants, live traffic control based on movement of spectators, predicted potential traffic issues, identified bottlenecks, visibility of the entire activity venue and all spectators, management of staff and security within the physical space of the activity venue, maintenance request, outstanding maintenance, ideal locations/items for maintenance, predictive equipment maintenance, security or other analytics. As would be appreciated by one skilled in the art, live traffic control can be a representation of a flow of traffic of individuals or subgroups of individuals throughout the activity venue. The individuals can be any combination of participants, spectators, operators, and staff members at the activity venue. Additionally, the data management tool 14 reports on equipment location and status such as if the equipment is idle, moving, and/or requires predictive maintenance based upon data obtained from the CAN bus. The data obtained from the CAN bus can include any data transmitted throughout the sensor device 10. For example, the data obtained from the CAN bus can include engine temperature, torque, engine load, fuel rates etc. for the equipment.

In operation, in accordance with an example embodiment of the present invention, the sensor device(s) 10 are associated with one or more of the participants (e.g., utilizing unique identifiers). As would be appreciated by one skilled in the art, the sensor device(s) 10 can be associated with a single participant (e.g., a participant registered a bag tag sensor device 10 attached to their bag). Alternatively, the sensor device(s) 10 can further be associated with a plurality of participants. For example, a party of participants registers with the same sensor device(s) 10 and relays the combination to the data management tool 14 (e.g., a group of four participants sharing a single sensor device 10). When a sensor device 10 has been associated with and/or registered to a participant or group of participants (e.g., with the venue gateway device 12 or data management tool 14), the data management tool 14 associates the sensor device 10 with the participant(s) within the system 100 (e.g., stored in a database) and data related to the location of the one or more participants is transmitted to the data management tool 14 (e.g., directly or via the venue gateway device 12) for storage and analysis. Additionally, as would be appreciated by one skilled in the art, the sensor device(s) 10 can be automatically or manually unlinked and/or disassociated with a participant upon a determination that the participant is no longer using the sensor device(s) 10 (e.g., the participant has left the activity venue or is no longer participating in the events at the venue).

In accordance with an example embodiment of the present invention, the sensor device(s) 10 is not associated with any participants. The unlinked sensor device(s) 10 can instead be associated with venue asset devices or venue asset tags unassociated with any participant. For example, a sensor device 10 can be attached to a venue asset (e.g., venue equipment) and associated with that venue asset (e.g., via a unique identifier) by the data management tool 14. In accordance with an example embodiment of the present invention, staff members and operators within the venue are associated with sensor device(s) 10. Similarly to tracking locations and times associated with the locations for participants and venue assets, the data management tool 14 tracks the location and time spent at locations for staff members and operators associated with the sensor device(s) 10.

Continuing with FIG. 1, in accordance with an example embodiment of the present invention, the operator device(s) 18 and/or spectator device(s) 20 are secondary computing devices used to supplement the other components of the system 100. For example, the operator device(s) 18 and/or spectator device(s) 20 can be mobile computing devices (e.g., smartphone, tablet, laptop, smart watch, etc.) or generic computing devices (e.g., desktop) used by operators and spectators, respectively, to access the system 100, data management tool 14, and the data stored thereon. As would be appreciated by one skilled in the art, the operator device(s) 18 and/or spectator device(s) 20 communicate with the data management tool 14 over the telecommunication network 16 and/or the venue gateway device 12 over a local area network (e.g., LoRa network) to access information provided by the system 100 through the use mobile/software applications, accessing through a webpage, or a combination thereof. In accordance with an example embodiment of the present invention, the venue gateway device 12 and one of the operator device(s) 18 is the same device.

In accordance with an example embodiment of the present invention, the operator device(s) 18 and/or spectator device(s) 20 include distinct software (e.g., mobile apps, software applications, etc.) configured to transmit, receive, and display specific data received from the data management tool 14. In particular, the operator device(s) include an event management application and the spectator device(s) 20 include event experience application configured to provide and receive data intended for the operators and spectators, respectively. The event application installed on the operator device(s) 18 and/or spectator device(s) 20 enables the devices to display information derived from information received from (by the data management tool 14) other operator device(s) 18 and/or spectator device(s) 20 as well as information gathered from the sensor device(s) 10.

The operator device(s) 18 and/or spectator device(s) 20 provide location and time data related to the location of the respective devices to the data management tool 14. In contrast to the sensor device(s) 10, the event applications running on the operator device(s) 18 and/or spectator device(s) 20 leverage location services (e.g., GPS, triangulation, etc.) of the devices to provide the location and time information directly to the data management tool 14. In other words, the operator device(s) 18 and/or spectator device(s) 20 are not computing devices specifically designed to work with the system 100 but are general purpose computing devices with specialized software installed thereon configured to provide data for utilization by the data management tool 14. As would be appreciated by one skilled in the art, the user of the respective devices can elect not to share location services of their device and the information on the event application will be limited accordingly (e.g., no location based information).

In accordance with an example embodiment of the present invention, each of the operator device(s) 18 and/or spectator device(s) 20 receives information tailored to the type of software installed on the respective devices based on the installed application (e.g., event management application or event experience application). In particular, the operator device(s) 18 running the event management application receive information relating to operations of that particular activity venue (e.g., event management) and the spectator device(s) 20 running the event experience application are operable to receive information relating spectators and participants at the activity venue related spectator experience (e.g., participant location within the venue, spectator congestion, etc.). For example, the operator device(s) 18 can receive data related to concession restocking, live traffic control of spectators at the venue, rate of progress of participants at the activity venue, spectator notifications, activity venue and sub-activities usage data, information related to maintenance, maintenance requests, time(s) and location(s) to perform maintenance, and operational statistics of the activity venue. In contrast, the spectator device(s) 20 can receive data related to rate of progress predictor for participants (e.g., projected start/finish time, projected locations, etc.), live venue traffic map, and ratings for the activity venue, navigation routes to preferred destinations, among other information.

Additionally, the data provided to the operator devices 18 and spectator devices 20 can include any combination of data aggregated by the data management tool 14 from the sensor devices 10, venue gateway device 12, operator devices 18, and spectator devices 20. As would be appreciated by one skilled in the art, the information provided to the operator device(s) 18 and spectator device(s) 20 can be accessed through a specific application (e.g., event management application or event experience application) designed for the operator devices 18 or spectator devices 20 or the operator device 18 and spectator device 20 can use existing mobile applications to access the information (e.g., access a webpage through a web browser, web portal, etc.).

FIGS. 2A and 2B depict example architectures of the sensor device 10, as discussed with respect to FIG. 1. As discussed herein, the sensor device(s) 10 can be a specialized device including a combination of components, including but not limited to, the microcontroller (MCU) 202, the transceiver 204, the global positioning system (GPS) locator 206, the battery power source 208, the LED 210, and the electronic ink (e-Ink) display 212. As would be appreciated by one skilled in the art, the components of the sensor device 10 can be substituted with components configured to perform the same functionality (e.g., GPS exchanged for cellular triangulation) as the components included in FIGS. 2A and 2B and can also include additional components to add customized and/or improved functionality for a given activity venue. For example, the sensor device 10 can include a charging port 214 to recharge the battery power source 208, a motion detection module to detect motion, a payment component (e.g., a smart chip), or other additional components. Similarly, the sensor device 10 can omit components to add customization and/or improved functionality for a given activity venue. For example, the sensor device(s) 10 integrated within venue assets may not require a display device because the sensor device(s) 10 for venue assets are primarily designed to give a reference location of a venue asset. Accordingly, the sensor device 10 for venue assets can be designed to without a display to reduce cost, size, and power usage.

In accordance with an example embodiment of the present invention, the MCU 202 is configured to perform any computations and data collection that are required by the sensor device 10. The transceiver 204 is configured to perform wireless transmission and reception of data with one or more other devices. For example, the transceiver 204 can be long range wide area network device (LoRa) or other radio frequency (RF) device to transmit data to the venue gateway device 12. As would be appreciated by one skilled in the art, the transceiver 204 can be operable to communicate over any combination of communication mediums including but not limited to Wi-Fi, cellular, radio frequency technologies, Bluetooth, etc. In accordance with an example embodiment of the present invention, the sensor device(s) 10 is configured to receive information from the venue gateway device 12, the data management tool 14, operator device(s) 18, spectator device(s) 20, and from other sensor device(s) 10 through the transceiver 204. The GPS locator 206 is configured to determine location data of the sensor device 10 for transmission by the transceiver 204 to venue gateway device 12. For example, as dictated by the MCU 202, location data obtained by the GPS locator 206 can be transmitted, via the transceiver 204, periodically, (e.g., every 20 seconds) to the venue gateway device 12.

Continuing with FIGS. 2A and 2B, the battery power source 208 provides power to the sensor device 10. For example, the battery power source 208 can be one or more Li-ion batteries. As would be appreciated by one skilled in the art, the battery power source 208 can include any power source known in the art suitable for a compact mobile sensor device. In accordance with an example embodiment of the present invention, the battery power source 208 is also configured to conserve power usage. For example, the battery power source 208 can be configured to supply power upon detection of motion of the sensor device 10 (e.g., via a motion detection device) and return to standby mode when the sensor device 10 is not in use (e.g., no motion is detected). As would be appreciated by one skilled in the art, the motion detection device can include an accelerometer, gyroscope, or other type of motion detection device known in the art. In accordance with an example embodiment of the present invention, motion can also be detected by identifying a change in location of the sensor device 10. For example, using the GPS locator 206, a determination that the sensor device 10 has moved to a new location. The change in location determination can be used in place of a motion detection device within the sensor device 10, or in conjunction with a motion detection device as a redundancy or for verification.

In accordance with an example embodiment of the present invention, the sensor device(s) 10 are also operable to receive and convey information and notifications to the users (e.g., participants) throughout the activity venue. In particular, the information or notifications can be conveyed to the participant carrying the sensor device 10 through a variety of visual cues. For example, the sensor device(s) 10 device can indicate to the participant that they have spent too long in a given location and should relocate. As would be appreciated by one skilled in the art, the information or notifications can be displayed to the participants on a display, such as a low energy display, including an e-Ink type display 212, or can be conveyed to the participants through a color display/change of the LED 210 on the sensor device 10. For example, the e-Ink type display 212 can display a distance to another sensor device 10 (e.g., a flag stick at a hole on a golf course).

Similarly, the LED 210 can change the displayed color to reflect how the participant is doing on their rate of progress relative to other participants, as determined by the data management tool 14 (e.g., green can reflect that the participant is ahead of the rate of progress, yellow can reflect that the participant is on rate of progress, or red can reflect that the participant is behind the rate of progress). For example, if the data management tool 14 determines that the participant is moving at a rate of progress slower than the rate of progress established by participants in front of and/or behind the participant, the LED will indicate the appropriate color for a slow rate of progress. In accordance with an example embodiment, the LED color can reflect a participant's rate of progress by comparing their progress in a given activity or sub-activity against a benchmark. For example, on a golf course, each hole has a par time (e.g., 15 minutes to complete a par 3 hole) and if a participant takes longer than a certain amount of time over the par time the light will change to reflect that they are over the par time (e.g., by turning the LED color to yellow or red).

In accordance with an example embodiment of the present invention, the e-Ink type display 212 is configured to carry out the same functions as discussed related to the LED 210. As would be appreciated by one skilled in the art, in the absence of an LED 210, the functions of the LED 210 can be executed and/or displayed by the e-Ink type display 212. For example, if a participant is behind a predicted rate of progress and has a sensor device 10 that is only equipped with an e-Ink type display 212, then the e-Ink type display 212 can display the color red (or text) to indicate to the participant that they are behind the rate of progress. Additionally, the e-Ink type display 212 or LED can be used to provide visual cues to staff working at the activity venue, For example, if there is a gap on at a certain location within the venue, a visual cue can be provide to the staff to be dispatched with certain equipment by sending a message to the e-Ink type display 212 and/or to a staff mobile application (e.g., on the operation device(s) 18).

In accordance with an example embodiment of the present invention, the sensor device(s) 10 also includes a button 216 to be used by a participant to initiate various functions on the sensor device(s) 10. For example, the button 216 can be an electromechanical button, or a touch sensitive button, that when pressed causes the sensor device(s) 10 display information to the participant. In accordance with an example embodiment of the present invention, pushing the button 216 causes the sensor device(s) 10 to initiate a call to the venue gateway device 12, requesting information and requested information is subsequently received from the venue gateway device 12 for display on the sensor device(s) 10 (e.g., via the LED 210, e-Ink type display 212, or combination thereof). For example, a participant pushes the button 216 on a sensor device 10 during a round of golf to request a distance to a pin at the current hole (also equipped with a sensor device 10). The venue gateway device 12 device can use the location information obtained from the participant's sensor device 10 and a sensor device 10 attached to the pin at the participant's current hole to determine the distance from the participant to the pin and return the value to the participant's sensor device 10 for display. As would be appreciated by one skilled in the art, the button 216 can be used to initiate other functionality. For example, pressing the button can allow a participant to toggle through views on the display device (e.g., menus, options, information, hole information, etc.), view a current rate of progress for the participant, view current charges applied to the participant's time at the activity venue, request a rules official to come to that location, etc.

Continuing with FIGS. 2A and 2B, in accordance with an example embodiment of the present invention, the components of the sensor device 10 are all included in a compact non-intrusive sized device (e.g., about 80 mm×48 mm×18 mm in size). The sensor device 10 are designed as a non-intrusive size as to not to detract from the user experience during an activity or sub-activity at an activity venue. For example, the sensor device 10 can be created in the form of a bag tag, key chain, a card, lanyard tags, or tickets. As would be appreciated by one skilled in the art, the sensor device 10 can be customizable for the particular activity venue in which they are being applied. For example, a golf course may have key chain sensor device 10 for each of the golf carts, golf bag tags sensor device 10 for each participant's golf bag, and an attachable device to a flag stick sensor device 10 attached to the flag at each hole on the course. Accordingly, the system 100 can utilize location data from all of the key chains, bag tags, equipment tag, cell phone application, and flags to provide analysis and provide the appropriate feedback to operators, staff, and spectators. The use of multiple compact sensor devices 10 can provide operators, staff, and spectators with a full view of all the activities and sub-activities occurring at the activity venue at a particular point in time.

In operation, operators, venue assets, and/or staff at an activity venue can be provided with sensor device(s) 10 and/or operator device(s) 18 with the event management application installed thereon. The device(s) 10, 18 provide location data, time data, and other information (e.g., tracking location, timestamps, identifiers, etc.) related to the operators, venue assets, and/or staff to a venue gateway device 12. The venue gateway device 12 transmits all collected location data, time data, and other collected tracking data or information to the data management tool 14 for storage/analysis. Additionally, the data management tool 14 obtains location, time data, and other information, independently of the venue gateway device 12, from operator device(s) 18 and spectator device(s) 20 (with the event applications installed thereon). The data management tool 14 is operable to aggregate and analyze the data received from the sensor device(s) 10, venue gateway device 12, operator device(s) 18, and spectator device(s) 20 and provide information to the participants, spectators, staff, and/or operators at the activity venue based on the aggregated data received from all devices, as discussed with respect to FIGS. 1 and 2A-2B.

In accordance with an example embodiment of the present invention, the data management tool 14 associates data received from each of the sensor device(s) 10, spectator device(s) 20, and/or operator device(s) 18 with a particular user (e.g., via unique identifier), type of user, and/or class of user (e.g., participant, worker, spectator, etc.). Accordingly, the data management tool 14 can identify each particular user and perform analytics on data received for the particular user, a group of users, and/or all users based on a desired result. For example, the data management tool 14 can display a location of all participants, operators or staff members, and/or spectators at an activity venue at any given point in time. Similarly, the data management tool 14 can display information (e.g., congestion, traffic flow, maintenance tasks, etc.) based on the location of all participants, staff members, and/or spectators at an activity venue at any given point in time.

As would be appreciated by one skilled in the art, the information is determined by the data management tool 14 by performing various analytics on the live location data. For example, the data management tool 14 can utilize the aggregated location and time data to develop predictive traffic patterns/flows, identify current and predicted locations for particular users, determining areas that may require attention from event staff (e.g., crowded areas that may require additional security, concession restocking, etc.). In accordance with an example embodiment of the present invention, the data management tool 14 can provide security evaluations to track locations of all security related staff and evaluate whether particular areas should have additional security staff present. Additionally, the data management tool 14 can provide recommendations for placement of security staff, redistribution of security staff, requesting additional security staff, etc. based on the data collected throughout the venue. Similarly, the data management tool 14 is configured to identify if participants, operators, spectators are in restricted areas and notify appropriate security staff of the unauthorized entry into the restricted areas, including a location of the violator.

In accordance with an example embodiment of the present invention, the aggregated data from devices 10, 12, 14, 18, and 20 can be utilized by the data management tool 14 to solve logistical problems that are unique to a particular venue. For example, the data management tool 14 can be utilized to solve logistical issues at an airport based on location data received devices associated with staff, luggage carts, luggage, equipment, etc. The logistical problems being solved can include merely informative information and/or complex operational efficiencies.

As would be appreciated by one skilled in the art, the data management tool 14 can collect data from multiple activity venue gateway devices 12, operator device(s) 18, and spectator device(s) 20 at multiple separate locations within an activity venue and/or at multiple separate and distinct activity venues/events to be used during the analytics. For example, the data management tool 14 can collect data from multiple convention centers and use the data received from the collection of convention centers to make certain determinations during the analysis of the aggregated data. Utilizing data from multiple venues provides the data management tool 14 with larger data sets to be utilized in the analytics to identify predictive behaviors, pattern recognition, etc.

In accordance with an example embodiment of the present invention, based on the determinations derived during the analysis by the data management tool 14, the data management tool 14 provides targeted feedback to the sensor device(s) 10, the gateway venue device(s) 12, the operator device(s) 18, and/or spectator device(s) 20. The targeted feedback provides information tailored for the spectators, staff members, and operators in a format designed to enhance spectator experiences, to optimally maintain the venue itself, and to maximize profitability for the activity venue. As would be appreciated by one skilled in the art, the analysis performed on the collected data can be modified and utilized with a variety of metrics tailored to different types of activity venues (e.g., concert venues, stadiums, convention centers, golf courses, skiing, amusement parks, marathons, tennis tournaments, triathlons, festivals, the Olympic® games, etc.).

As discussed with respect to FIGS. 1 and 2A-2B, the data management tool 14 provides feedback to the participants, spectators, and operators or staff via the sensor device(s) 10, spectator device(s) 20, and/or operator device(s) 18. The type of feedback/information provided to the respective devices/users can be based on the type of user. For example, spectator users (e.g., users of spectator devices 20) are provided with feedback related to venue usage including locations of participants, instructions to proactively avoid potential congestion, directions to a particular point of interest, etc. In contrast, operators and staff users (e.g., users of operator devices 18 and/or sensor devices 10) are provided with feedback related to venue usage including instructions to relieve congestion at particular locations within the activity venue, maintenance tasks to be carried out at the venue, etc. As would be appreciated by one skilled in the art, the type of feedback can be provided based on a type of device/user (e.g., sensor devices 10, spectator devices 20, and/or operator devices 18) and/or a type of application running on those devices (e.g., event management application or event experience application). Overall, the instructions are data driven actionable recommendations responsive to analytics on the venue usage performed by the data management tool 14.

In accordance with an example embodiment of the present invention, the data management tool 14 provides the operator devices 18 and spectator device 20 with real-time information populated within a map of the activity venue. The map can include general boundaries, pathways, other static structures, etc. Additionally, the map can include specific points of interest including concessions, restrooms, merchandise tents, etc. As would be appreciated by one skilled in the art, the points of interest can include a combination of static and mobile objects. In accordance with an example embodiment of the present invention, each of the objects (e.g., concessions, restrooms, merchandise tents) that are mobile is tagged with a sensor device 10 such that the map can be automatically updated to include the locations and status information (e.g., out of order) of the concessions, restrooms, merchandise tents, etc. This is beneficial for activity venues that are not static and may be subject to different configurations when hosting different events. Additionally, each of the concessions, restrooms, merchandise tents, etc. can be associated with a particular geometric shape and dimension which can be inserted within the map of the activity venue.

In accordance with an example embodiment of the present invention, location data for the locations of participants, spectators, staff, etc. is provided to users as an overlay on a map of the venue (e.g., on spectator device 20, operator devices 18, etc.). Additionally, an operational dashboard is provided by the data management tool 14 to display location information, statistics, and other information to users (e.g., supervisors, staff, managers, etc.). The operational dashboard can include a variety of preferences and views to customize usage for particular tasks. For example, an event manager may utilize an event management dashboard which only requires location information for spectators, staff members, equipment such that the information necessary for managing the event is provided without unnecessary information. As would be appreciated by one skilled in the art, the provided information can be customized and different filters or criteria can be enabled or disabled based on user preference.

In accordance with an example embodiment of the present invention, for operators or supervisors of the activity venue, the data management tool 14 provides an operational dashboard for displaying information related to users throughout the activity venue and a map of the activity venue itself. The operational dashboard displays statistics and information about the activity venue including but not limited to levels of congestion, capacity, spectator locations, facility status information, etc. Additionally, the data management tool 14 provides outside information to users via the operational dashboard. For example, the data management tool 14 can gather data and provide the gathered data related to current weather conditions, providing advisory notifications to spectators and participants, etc.

In accordance with an example embodiment of the present invention, the data management tool 14 provides event managers or supervisors an event management dashboard with information related to the event being hosted at the activity venue. The information within the event management dashboard can include but is not limited to configuration of the event venue, statistics for participants in the event, to event managers through event dashboard. Additionally, event managers or supervisors can independently track tournament operations equipment location and tournament staff around the activity venue (independently from activity venue equipment and staff). As would be appreciated by one skilled in the art, the locations for equipment and activity staff can be tracked through sensor devices 10 associated therewith. For example, the event management dashboard can overlay the locations of all event equipment and staff on the map for the activity venue.

In accordance with an example embodiment of the present invention, the event management dashboard enables the event managers or supervisors to use the dashboard to provide feedback for managing the event, event staff, and event equipment. For example, the event management dashboard can be utilized to rebalance staff (e.g., security, merchants, custodial, etc.) based upon identified traffic patterns of spectators. The event management dashboard can communicate feedback instructions to event staff, located throughout the activity venue, related to tasks to be carried out. The event management dashboard can further provide a task manager dispatch function to provide the feedback through an independent communications channel. In particular, the event management dashboard provides a system that can be used as a dispatch system and a communication system outside of the short wave radio systems. For example, the event management dashboard can provide an event staff member with instructions to “bring more keg beer to booth 25” via an operations staff mobile applications (e.g., on operator device 18) that is connected to the network coverage through the local area network (e.g., LoRa).

Additionally, the data management tool 14 is able to predict certain metrics based on a combination of aggregated data from all of the devices within the system 100. For example, based on a high level of spectators around a concession stand, the data management tool 14 can proactively predict when a certain beer stand needs restocking based upon the congestion and/or sales data. When such a prediction is made, the data management tool 14 can also recommend dispatching staff to the location of the prediction to perform a task related to the prediction (e.g., replace a keg of beer). Similarly, the data management tool 14 can recommend ideal locations for concessions or merchandise based upon course characteristics, spectator congestion, and/or other data. In accordance with an example embodiment of the present invention, participants, the data management tool 14 can use the dashboard to display location information for the equipment used to manage the event and the staff and security to coordinate tasks. For example, the event management dashboard can be utilized to show the closest staff member to concession stand 25 to be dispatched to refill the beer keg. Additionally, the data management tool 14 can provide a search operation to locate a specific piece of equipment or staff member. As would be appreciated by one skilled in the art, the operational dashboard can provide similar functionality to monitor and dispatch activity venue staff independently from event staff or both.

In accordance with an example embodiment of the present invention, as discussed herein, the data management tool 14 is configured to provide traffic optimization of spectators throughout an activity venue. The data management tool 14 utilizes collected location and time data from the spectator devices 20 throughout an activity venue to perform analytics related to predicting areas of congestion, identifying bottlenecks, recognizing issues in usage, and estimating wait times. As would be appreciated by one skilled in the art, the prediction and identification includes utilizing the aggregated data for predicting gaps, delays, and/or bottlenecks for a particular time of day, day of the week, time of year, etc. In addition to the analytics, the data management tool 14 generates metrics to resolve the issues identified by the analytics. For example, the data management tool 14 can identify areas of congestions and/or causes of congestions and take steps to mitigate the congestions and/or causes of congestion (e.g., direct spectators to avoid the congestion, dispatch staff to perform traffic control, etc.).

In accordance with an example embodiment of the present invention, the data management tool 14 can combine spectator location information with rate of progress predictions for participants to provide additional information to operators, staff, or supervisors. For example, based in part on rate of progress determinations and locations of other participants and spectators, proactive instructions are conveyed to the operators and/or staff to mitigate potential bottleneck issues and/or perform maintenance. For example, if a popular participant is approaching a heavy traffic area or an area with another participant, the data management tool 14 can provide staff with instructions to compensate for increased levels of spectators in the projected area at the projected time.

In accordance with an example embodiment of the present invention, participants within the activity venue can be associated with sensor devices 10 to be carried with them and the data management tool 14 actively tracks the locations of the participants during participation in the event. As the participants move throughout the activity venue their locations are automatically updated for display to user devices (e.g., on a map display on operator device 18, spectator devices 20, etc.). The locations of participants are displayed to operators, staff members, and spectators alike on their respective devices 10, 18, 20 (e.g., as map overlays). In accordance with an example embodiment of the present invention, the sensor devices 10 carried by participants enable the participants with some additional functionality provided by the data management tool 14, without requiring participants to download applications on their personal devices for use by the activity venue. The additional functionality includes conveying information to the participant either unprompted or upon request from the sensor device 10. For example, the sensor device 10 is configured to enable participants to push a button to call rules officials for the activity being partaken in by the participant. Additionally, data management tool 14 can provide unprompted feedback to the sensor devices 10 being carried by the participants. For example, as discussed herein the data management tool 14 tracks rate of progress metrics for each participant, and the data management tool 14 can put participants “on the clock” with warnings of slow play (e.g., via display or LED coloration on the sensor device 10). As would be appreciated by one skilled in the art, the rate of progress can be determined utilizing any combination of methodologies and algorithms known in the art.

In accordance with an example embodiment of the present invention, spectators with the event experience application installed on their devices (e.g., spectator devices 20) can receive data designed to enhance the spectator experience during the event. In particular, the event experience application can include a spectator specific dashboard to display information about the event, a map of the event venue, and other useful information. For example, the dashboard can deliver location information to the spectator experience application so fans know where specific participants are within the activity venue. Additionally, the data management tool 14 can utilize or leverage predictive algorithms (e.g., participant rate of progress algorithms) to predict where participants will be at a future point in time and convey that information to the spectators. For example, the dashboard can display where a spectator's favorite participant will be at 1 PM so the spectator can plan accordingly to arrive at the location at the predicted time. Similarly, the dashboard can provide navigation instructions such that the spectator can plan a route of participants the spectator would like to see. The navigation instructions can include navigating spectators through walkways and fan friendly areas to find/follow participants they are interested in. Similarly, the navigation instructions can provide a custom route so a spectator can “plan their own viewing experience” by selecting different participants that the spectator likes and have the dashboard provide a suggested route to most efficiently see all the participants.

In accordance with an example embodiment of the present invention, the dashboard provides spectators with location information for other spectators within the activity venue. In particular, as discussed herein, the data management tool 14 tracks spectator use of the activity venue (e.g., location data) and conveys the tracked spectators through the event experience application (e.g., display how many people are in certain areas, for how long etc.). Additionally, the data management tool 14 predicts spectator traffic and conveys the predictions to the spectators to inform best access to view the events, food and beverage vending, bathrooms, etc.

In accordance with an example embodiment of the present invention, the dashboard provides additional information and alerts to the spectators based on information gathered from the event. For example, the dashboard sends alerts to spectators of player scores, statistics, leaderboards, etc. The information further includes displaying interesting parts of the activity venue or events due to levels of difficulty for the participant activities/competition, momentum changes in competition, etc. The statistics also include information about the activity venue itself.

In accordance with an example embodiment of the present invention, the data management tool 14 is configured to maintain historical tracked activity (e.g., location and time data). In particular, the data management tool 14 utilizes a tracking tool to monitor the locations of via the sensor device(s) 10, spectator device(s) 20, and/or operator device(s) 18 throughout the activity venue. The tracking tool receives, monitors, and stores the locations for each of the devices throughout the venue and associates the location and timestamps with the identifiers associated with each respective device(s). The historical data is used in conjunction with the live data to create metrics for an improved analysis. For example, the historical data can be used to more accurately determine estimated wait times, predict spectator traffic, identify a typical duration to perform a particular form of maintenance, etc. In accordance with an example embodiment of the present invention, the historical data collected for each sensor device 10, spectator device 20, and/or operator device 18 can be utilized by the data management tool 14 to perform any combination of analytics and metrics (e.g., for spectator experience, maintenance, etc.).

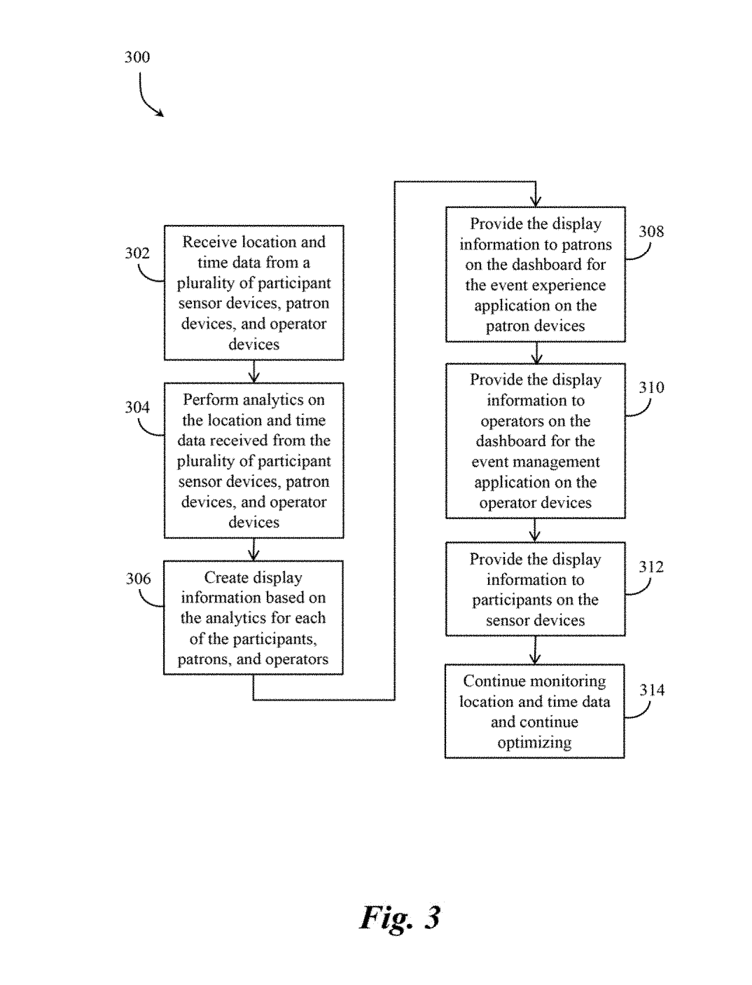

FIG. 3 shows an exemplary flow chart depicting implementation of the present invention. In particular, FIG. 3 depicts actions performed by the data management tool 14 in conjunction with the other components of the system 100 during process 300. At step 302, the data management tool 14 receives location and time data from a plurality of participant sensor devices 10, spectator devices 20, and operator devices 18. At step 304, the data management tool 14 performs analytics on the location and time data received from the plurality of participant sensor devices, spectator devices, and operator devices. At step 306, the data management tool 14 creates display information based on the analytics for each of the participants, spectators, and operators. At step 308, the data management tool 14 provides the display information to spectators on the dashboard for the event experience application on the spectator devices 20. At step 310, the data management tool 14 provides the display information to operators on the dashboard for the event management application on the operator devices 18. At step 312, the data management tool 14 provides the display information to participants on the sensor devices 10. As would be appreciated by one skilled in the art, the display information can include the feedback information as discussed herein. At step 314, the data management tool 14 can continuing monitoring the location and time data provided by the sensor device(s) 10, spectator device(s) 20, and operator device(s) 18 at the activity venue and re-optimize accordingly. In particular, the data shared on the screen provides automated insights and action steps for all, based on the parameters and rules that drive the system 100.

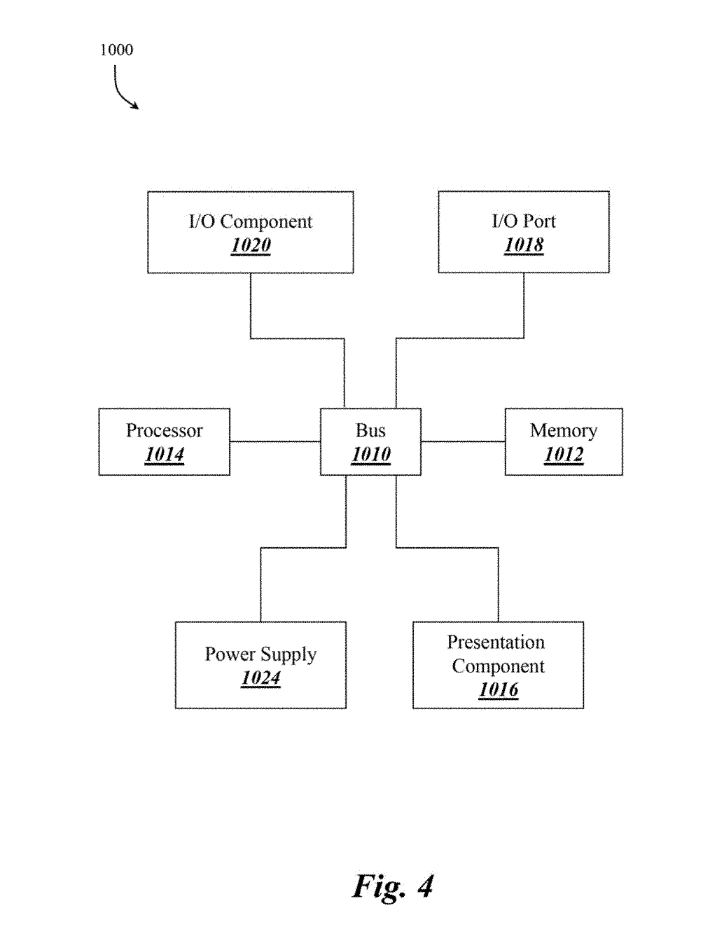

Any suitable hardware device can be used to implement the various sensor and computing devices 10, 12, 14, 16, 18, 20 and methods/functionality described herein and be converted to a specific system for performing the operations and features described herein through modification of hardware, software, and firmware, in a manner significantly more than mere execution of software on a generic computing device, as would be appreciated by those of skill in the art. One illustrative example of such a computing device 1000 is depicted in FIG. 4. The computing device 1000 is merely an illustrative example of a suitable computing environment and in no way limits the scope of the present invention. A “computing device,” as represented by FIG. 4, can include a “workstation,” a “server,” a “laptop,” a “desktop,” a “hand-held device,” a “mobile device,” a “tablet computer,” or other computing devices, as would be understood by those of skill in the art. Given that the computing device 1000 is depicted for illustrative purposes, embodiments of the present invention may utilize any number of computing devices 1000 in any number of different ways to implement a single embodiment of the present invention. Accordingly, embodiments of the present invention are not limited to a single computing device 1000, as would be appreciated by one with skill in the art, nor are they limited to a single type of implementation or configuration of the example computing device 1000.

The computing device 1000 can include a bus 1010 that can be coupled to one or more of the following illustrative components, directly or indirectly: a memory 1012, one or more processors 1014, one or more presentation components 1016, input/output ports 1018, input/output components 1020, and a power supply 1024. One of skill in the art will appreciate that the bus 1010 can include one or more busses, such as an address bus, a data bus, or any combination thereof. One of skill in the art additionally will appreciate that, depending on the intended applications and uses of a particular embodiment, multiple of these components can be implemented by a single device. Similarly, in some instances, a single component can be implemented by multiple devices. As such, FIG. 4 is merely illustrative of an exemplary computing device that can be used to implement one or more embodiments of the present invention, and in no way limits the invention.

The computing device 1000 can include or interact with a variety of computer-readable media. For example, computer-readable media can include Random Access Memory (RAM); Read Only Memory (ROM); Electronically Erasable Programmable Read Only Memory (EEPROM); flash memory or other memory technologies; CDROM, digital versatile disks (DVD) or other optical or holographic media; magnetic cassettes, magnetic tape, magnetic disk storage or other magnetic storage devices that can be used to encode information and can be accessed by the computing device 1000.

The memory 1012 can include computer-storage media in the form of volatile and/or nonvolatile memory. The memory 1012 may be removable, non-removable, or any combination thereof. Exemplary hardware devices are devices such as hard drives, solid-state memory, optical-disc drives, and the like. The computing device 1000 can include one or more processors that read data from components such as the memory 1012, the various I/O components 1016, etc. Presentation component(s) 1016 present data indications to a user or other device. Exemplary presentation components include a display device, speaker, printing component, vibrating component, etc.

The I/O ports 1018 can enable the computing device 1000 to be logically coupled to other devices, such as I/O components 1020. Some of the I/O components 1020 can be built into the computing device 1000. Examples of such I/O components 1020 include a microphone, joystick, recording device, game pad, satellite dish, scanner, printer, wireless device, networking device, and the like.

As utilized herein, the terms “comprises” and “comprising” are intended to be construed as being inclusive, not exclusive. As utilized herein, the terms “exemplary”, “example”, and “illustrative”, are intended to mean “serving as an example, instance, or illustration” and should not be construed as indicating, or not indicating, a preferred or advantageous configuration relative to other configurations. As utilized herein, the terms “about”, “generally”, and “approximately” are intended to cover variations that may existing in the upper and lower limits of the ranges of subjective or objective values, such as variations in properties, parameters, sizes, and dimensions. In one non-limiting example, the terms “about”, “generally”, and “approximately” mean at, or plus 10 percent or less, or minus 10 percent or less. In one non-limiting example, the terms “about”, “generally”, and “approximately” mean sufficiently close to be deemed by one of skill in the art in the relevant field to be included. As utilized herein, the term “substantially” refers to the complete or nearly complete extend or degree of an action, characteristic, property, state, structure, item, or result, as would be appreciated by one of skill in the art. For example, an object that is “substantially” circular would mean that the object is either completely a circle to mathematically determinable limits, or nearly a circle as would be recognized or understood by one of skill in the art. The exact allowable degree of deviation from absolute completeness may in some instances depend on the specific context. However, in general, the nearness of completion will be so as to have the same overall result as if absolute and total completion were achieved or obtained. The use of “substantially” is equally applicable when utilized in a negative connotation to refer to the complete or near complete lack of an action, characteristic, property, state, structure, item, or result, as would be appreciated by one of skill in the art.

Numerous modifications and alternative embodiments of the present invention will be apparent to those skilled in the art in view of the foregoing description. Accordingly, this description is to be construed as illustrative only and is for the purpose of teaching those skilled in the art the best mode for carrying out the present invention. Details of the structure may vary substantially without departing from the spirit of the present invention, and exclusive use of all modifications that come within the scope of the appended claims is reserved. Within this specification embodiments have been described in a way which enables a clear and concise specification to be written, but it is intended and will be appreciated that embodiments may be variously combined or separated without parting from the invention. It is intended that the present invention be limited only to the extent required by the appended claims and the applicable rules of law.

It is also to be understood that the following claims are to cover all generic and specific features of the invention described herein, and all statements of the scope of the invention which, as a matter of language, might be said to fall therebetween.

What is claimed is:

1. A system for real-time event management for use within an activity venue hosting an event, the system comprising:
a wireless gateway;
a plurality of sensor devices associated with a plurality of participants in the event for disposition and transportation throughout the activity venue, each of the plurality of sensor devices comprising:
a location sensor that provides location and time data of the plurality of sensor devices at different points in time within the activity venue; and
a wireless communication device that communicates with the wireless gateway by transmitting the location and time data from the plurality of sensor devices to the wireless gateway, enabling the system to establish a real-time location of each of the plurality of participants in the event based on location of the plurality of sensor devices within the activity venue;
event experience applications executing on one or more spectator devices, each of the one or more spectator devices associated with spectators attending the event;
event management applications executing on one or more operator devices, each of the one or more operator devices associated with operators of the activity venue; and
a data management tool configured to provide the event experience applications and the event management applications with real-time location information of the plurality of sensor devices associated with the plurality of participants.

2. The system of claim 1, wherein the one or more spectator devices comprise:
location services that provide location and time data indicating a location of the one or more spectator devices at different points in time within the activity venue; and
a wireless communication device that communicates with the system by transmitting the location and time data from the one or more spectator devices to the system, enabling the system to establish real-time location information for each of the one or more spectator devices, and therefore spectators associated therewith, within the activity venue.

3. The system of claim 2, wherein:
the data management tool receives location and time data for each of the plurality of participants from the plurality of sensor devices via the wireless gateway and receives location and time data for each of the spectators directly from the event experience applications executing on the one or more spectator devices; and
the data management tool transforms the location and time data from the plurality of sensor devices and the location and time data from the one or more spectator devices into predicted location data indicating anticipated locations of each of the plurality of participants and each of the spectators within the activity venue at future times.

4. The system of claim 3, wherein the predicted location data includes prediction of a future location of the plurality of participants at a future point in time based on a rate of progress of the plurality of participants.

5. The system of claim 3, wherein the data management tool measures and predicts congestion of spectators within the activity venue based on the location and time data for each of the one or more spectator devices.

6. The system of claim 5, wherein the data management tool recommends locations for point-of-sale terminals based on predetermined characteristics of the activity venue and the location and time data for each of the one or more spectator devices.

7. The system of claim 6, wherein the data management tool receives sales data from the point-of-sale terminals located at the activity venue.

8. The system of claim 7, wherein the data management tool pre-emptively issues notifications to the one or more operator devices to instruct the operators to perform management tasks at one or more specific locations within the activity venue based on the received sales data and the measured and predicted congestion of spectators within the activity venue.

9. The system of claim 8, where the notifications issued to the one or more operator devices include at least one of crowd control instructions, dispatch venue vehicles to transport spectators, cash out instructions, refreshment restocking instructions, and cleaning instructions.

10. The system of claim 1, further comprising one or more venue asset tags communicating with the wireless gateway and providing location and time data for the one or more venue asset tags.

11. The system of claim 10, wherein the one or more venue asset tags are attachable to, or integrated into, at least one of a piece of venue equipment, a venue vehicle, refuse containers, and a venue sign.

12. The system of claim 1, wherein the data management tool is further configured to provide information to at least an operator of the activity venue, the information related to at least one of: sub-activity time management, participant matching, live traffic control, statistics related to tracked movements of the one or more spectator devices, predictive analytics of the one or more spectator devices, layout of the activity venue, and maintenance of the activity venue.

13. The system of claim 1, wherein the data management tool provides information to the one or more spectator devices within the activity venue, the information related to at least one of: rate of progress for the plurality of participants, sub-activity start times, statistics, and weather.

14. The system of claim 1, wherein each of the plurality of sensor devices comprise at least one of a bag tag, a key chain, equipment tag, cell phone application, and a card.

15. The system of claim 1, wherein the wireless gateway comprises a long range wide area network (LoRa) gateway.

16. The system of claim 1, wherein the data management tool is a cloud based computing device infrastructure.

17. The system of claim 1, wherein the data management tool is further configured to provide navigation instructions to the one or more spectator devices through the event experience applications.

18. The system of claim 17, wherein the navigation instructions comprise best route navigation instructions between a location of one of the one or more spectator devices to a point of interest at the activity venue based on the location and time data for each of the one or more spectator devices and the location and time data for each of the plurality of spectators.

19. The system of claim 18, wherein the point of interest includes at least one of: one or more of the plurality of participants, a particular point of sale terminal, restrooms, and areas of low congestion of spectators.

20. A method for real-time event management for use within an activity venue hosting an event using a system for real-time event management, the method comprising:
the system associating a plurality of sensor devices with a plurality of participants in the event for disposition and transportation throughout the activity venue, each of the plurality of sensor devices comprising:
a location sensor that provides location and time data of the plurality of sensor devices at different points in time within the activity venue; and
a wireless communication device that communicates with a wireless gateway by transmitting the location and time data from the plurality of sensor devices to the wireless gateway to establish a real-time location of each of the plurality of participants in the event based on location of the plurality of sensor devices within the activity venue;
the system receiving location and time data from the plurality of sensor devices;
the system performing analytics on the location and time data received from the plurality of sensor devices;
the system creating display information based on the analytics for users of each of the plurality of sensor devices; and
the system generating the display information and providing the display information to the users of each of the plurality of sensor devices with real-time location information of the plurality of sensor devices associated with the users.
